(19) United States
(12) Patent Application Publication
(10) Pub. No.: US 2015/0101489 A1
(43) Pub. Date: Apr. 16, 2015

(54) Locking Device and Capsule Coffee Machine Having the Same

(71) Applicant: Tsann Kuen (Zhangzhou) Enterprise Co., Ltd., Zhangzhou (CN)

(72) Inventor: Yan-Xiang Zhang, Zhangzhou (CN)

(21) Appl. No.: 14/508,529

(22) Filed: Oct. 7, 2014

(30) Foreign Application Priority Data
Oct. 14, 2013 (CN) 201320632773.2

(51) Int. Cl. A47J 31/44; A47J 31/40

(52) U.S. Cl. CPC A47J 31/4403; A47J 31/407
USPC 99/295

(57) ABSTRACT

A locking device includes a lower main body having at least one first engaging portion, an upper cover pivotally connected to and openably covering the lower main body, and a locking mechanism including first and second locking members pivotally mounted on the upper cover, a locking spring urging the locking members to move toward a locking position, and a handle to control pivoting of the first locking member. The first locking member includes a first retaining portion, and a second engaging portion releasably engageable with the first engaging portion. The second locking member has a second retaining portion releasably engageable with the first retaining portion.

### CROSS REFERENCE TO RELATED APPLICATION

This application claims priority of Chinese Patent Application No. 201320632773.2, filed on Oct. 14, 2013.

### FIELD OF THE INVENTION

The invention relates to a locking device, more particularly to a locking device that can lock and unlock two components, and a capsule coffee machine having the same.

### BACKGROUND OF THE INVENTION

Conventionally, to brew coffee, it is necessary to grind first the coffee beans into powder using a grinding machine, after which a coffee machine is used for brewing and filtering. To make the coffee simpler and to maintain its flavor, there exists in the market a capsule coffee machine which uses a coffee capsule. The coffee capsule mainly contains ground coffee with a stable flavor sealed in a capsule. During brewing, the coffee capsule is pierced by the capsule coffee machine, after which hot water is poured into the capsule. Hence, a coffee beverage having a stable flavor can be obtained. However, during use of the coffee capsule, a high operating temperature is necessary, and a top cover of the machine must be frequently opened for replacement of the coffee capsules. Thus, attention must be paid to the operation as well as safe use of the existing capsule coffee machine. Apart from the aforesaid capsule coffee machine, other home appliances, for example, thermos bottles, also have similar problems.

From the aforesaid description, during use of the existing capsule coffee machine or the thermos bottle, a top cover thereof must be opened to permit placement or replacement of a coffee capsule or addition of water, a locking plate is used to maintain its closed state, and a handle is used to operate the locking plate. However, sometimes the handle of this type of home appliances may be mistakenly touched, causing the locking plate to deviate. When the top cover is to be closed, because the position of the locking plate is changed, a closing operation of the top cover cannot be smoothly performed.

### SUMMARY OF THE INVENTION

Therefore, an object of the present invention is to provide a locking device that is capable of overcoming the aforesaid drawbacks of the prior art.

Another object of this invention is to provide a capsule coffee machine having the aforesaid locking device.

According to one aspect of this invention, a locking device comprises a lower main body having an unlocking piece and at least one first engaging portion, an upper cover pivotally connected to and openably covering the lower main body, and a locking mechanism including a first locking member pivotally mounted on the upper cover, a second locking member pivotally mounted on the upper cover in proximity to the first locking member, a locking spring urging the first and second locking members to move toward a locking position, and a handle mounted on the upper cover to control pivoting of the first locking member. The first locking member includes a primary locking plate having a first retaining portion, and a second engaging portion releasably engageable with the first engaging portion. The second locking member has a second retaining portion releasably engageable with the first retaining portion, and an unlocking portion corresponding to the unlocking piece. When the upper cover is in a covering position, the second engaging portion engages the first engaging portion, and the first retaining portion disengages from the second retaining portion so that the first and second locking members are disposed in an unlocking position. When the handle drives the first locking member to pivot, the second engaging portion disengages from the first engaging portion, and the locking spring pulls the first and second locking members toward engagement with each other to switch the first and second members from the unlocking position to the locking position.

According to another aspect of this invention, a capsule coffee machine for brewing coffee from a coffee capsule comprises a housing, a locking device mounted in the housing, and a brewing unit. The locking device includes a lower main body having an unlocking piece and at least one first engaging portion, an upper cover pivotally connected to and openably covering the lower main body, and a locking mechanism. The locking mechanism includes a first locking member pivotally mounted on the upper cover, a second locking member pivotally mounted on the upper cover in proximity to the first locking member, a locking spring urging the first and second locking members to move toward a locking position, and a handle mounted on the upper cover to control pivoting of the first locking member. The first locking member includes a primary locking plate having a first retaining portion, and a second engaging portion releasably engageable with the first engaging portion. The second locking member has a second retaining portion releasably engageable with the first retaining portion, and an unlocking portion corresponding to the unlocking piece. When the upper cover is in a covering position, the second engaging portion engages the first engaging portion, and the first retaining portion disengages from the second retaining portion so that the first and second locking members are disposed in an unlocking position. When the handle drives the first locking member to pivot, the second engaging portion disengages from the first engaging portion, and the locking spring pulls the first and second locking members toward engagement with each other to switch the first and second members from the unlocking position to the locking position. The brewing unit is disposed in the upper cover.

### BRIEF DESCRIPTION OF THE DRAWINGS

Other features and advantages of the present invention will become apparent in the following detailed description of the embodiment with reference to the accompanying drawings, of which:

FIG. 1 is a perspective view of a capsule coffee machine according to the embodiment of the present invention; FIG. 2 is an exploded perspective view of a locking device of the embodiment;

FIG. 3 is a partly sectional view of the locking device, illustrating an upper cover of the locking device in an open position;

FIG. 4 is an exploded perspective view of a locking mechanism of the locking device;

FIG. 5 is a sectional side view of the locking device, illustrating a first engaging portion of a sliding body portion of a lower main body thereof and a second engaging portion of a first locking member of the locking mechanism in an engaging position;

FIG. 6 is a sectional view of the locking device, illustrating the upper cover thereof in a covering position;

FIG. 7 is a view similar to FIG. 5, but with the first and second engaging portions in a non-engaging position; and

FIG. 8 is a view similar to FIG. 5, but illustrating first and second locking members of the locking mechanism in a locking position.

### DETAILED DESCRIPTION OF THE EMBODIMENT

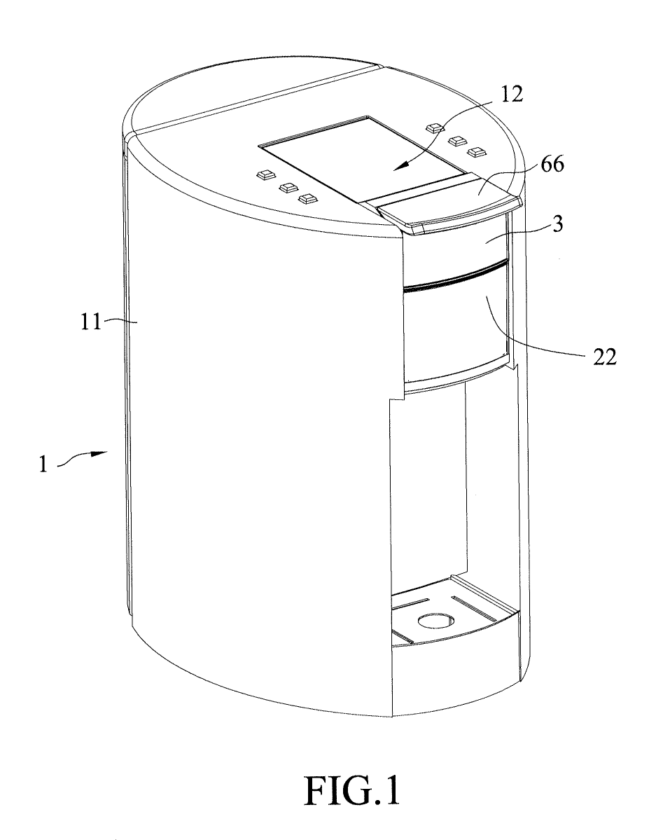

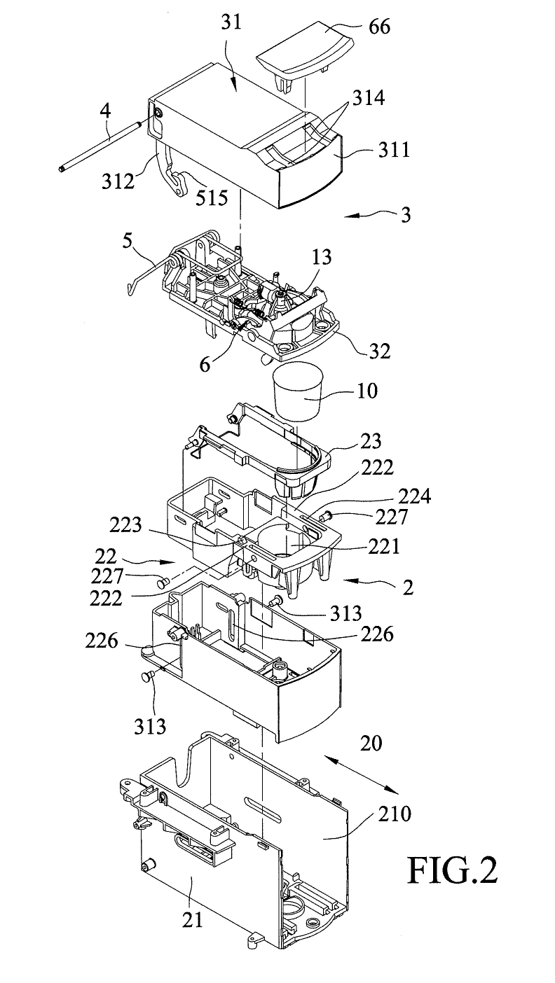

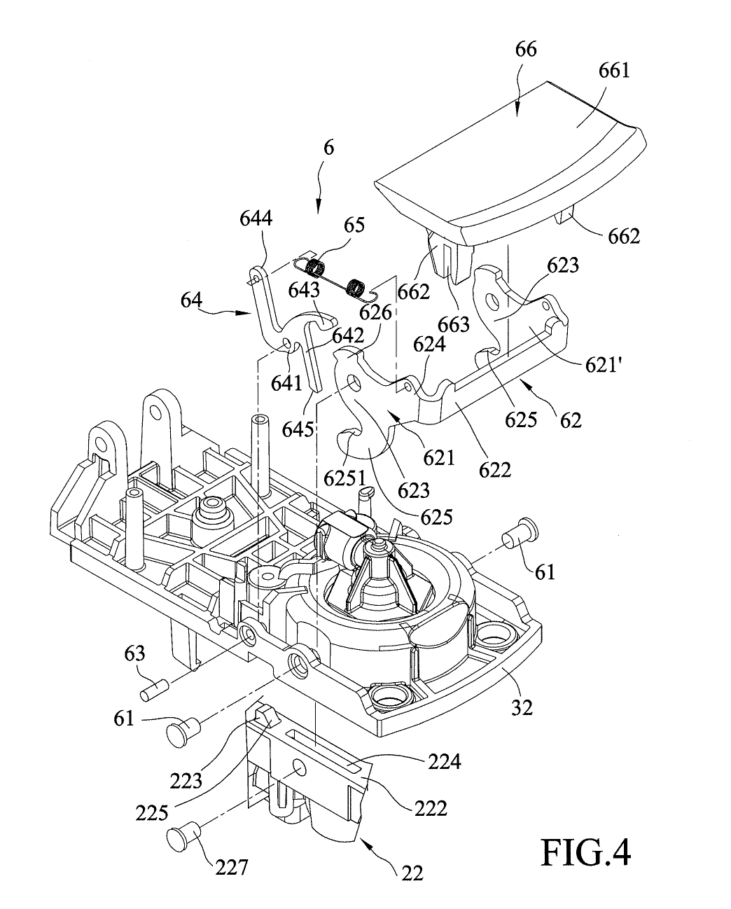

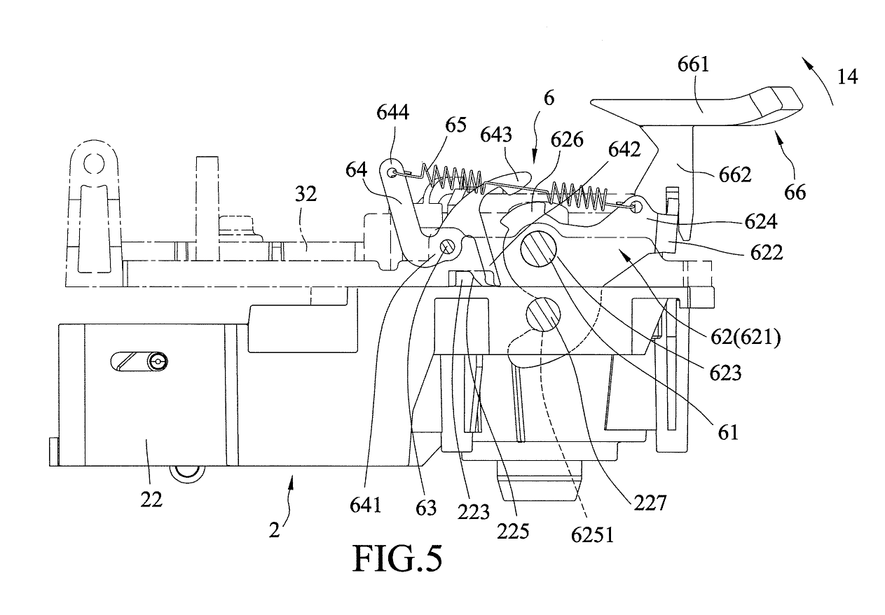

Referring to FIGS. 1 to 8, a capsule coffee machine 1 according to the embodiment of the present invention can brew coffee from a coffee capsule 10, and is shown to comprise a housing 11, a locking device 12 mounted in the housing 11 in proximity to a front top thereof, and a brewing unit 13.

The locking device 12 includes a lower main body 2, an upper cover 3, a main shaft 4 for pivotally mounting the upper cover 3 on the lower main body 2, a torsion spring 5 sleeved on the main shaft 4 for biasing the upper cover 3 to pivot to an open position along an opening direction 14, and a locking mechanism 6 for releasably engaging the upper cover 3 and the lower main body 2. The brewing unit 13 is disposed in the upper cover 3.

The lower main body 2 includes a fixed body portion 21, a sliding body portion 22, and an inclinable capsule-supporting frame 23 mounted pivotably on the sliding body portion 22 for supporting the coffee capsule 10. The fixed body portion 21 defines an accommodation space 210 extending along a sliding direction 20. The sliding body portion 22 is mounted in the accommodation space 210, and is slidable relative to the fixed body portion 21 along the sliding direction 20. The sliding body portion 22 includes a brewing chamber 221 for receiving the coffee capsule 10 therein, two lateral frames 222 respectively disposed on left and right sides of the chamber 221, and an unlocking piece 223 projecting upward from a top face of one of the lateral frames 222. Each lateral frame 222 has an elongated through hole 224 formed in the top face thereof and extending in a length direction thereof. The unlocking piece 223 has a first inclined face 225 extending inclinedly, upwardly and rearwardly from the top face of the one of the lateral frames 222. The sliding body portion 22 further includes two slide guide grooves 226 respectively formed in the lateral frames 222 and extending in a direction transverse to the length direction thereof, and two first engaging portions 227 respectively disposed on the lateral frames 222 in proximity to the through holes 224.

In this embodiment, each of the first engaging portions 227 is in the form of an insert pin.

The upper cover 3 includes an outer frame 31, and a brewing-supporting frame 32 disposed in the outer frame 31 for supporting the brewing unit 13. The outer frame includes a frame body 311 encapsulating the brewing-supporting frame 32, two push-pull rods 312 symmetrically spaced apart from each other in a left-right direction and extending downwardly, forwardly, and arcuately from a rear end of the frame body 311, and two slide pins 313 respectively extending through and respectively slidable along the slide guide grooves 226. Each slide pin 313 is further connected to a bottom end of a respective push-pull rod 312. As such, when the upper cover 3 pivots about the main shaft 4, the push-pull rods 312 can drive the sliding body portion 22 to slide reciprocally within the accommodation space 210 along the sliding direction 20. Moreover, the frame body 311 has two insert slots 314 spaced apart in the left-right direction, extending along a length direction thereof, and proximate to a front top thereof.

The locking mechanism 6 is used to engage and disengage the upper cover 3 with and from the lower main body 2. That is, by using the locking mechanism 6 to engage together the upper cover 3 and the lower main body 2, it is ensured that the upper cover 3 cannot be opened during brewing of the coffee capsule 10, so that safe use and smooth operation of the capsule coffee machine can be enhanced. In this embodiment, the locking mechanism 6 includes a first locking member 62, a second locking member 64, a locking spring 65, and a handle 66.

The first locking member 62 is pivotally mounted on the brewing-supporting frame 32 by two first pivot pins 61, and includes a primary locking plate 621, a secondary locking plate 621′ spaced apart from and parallel to the primary locking plate 621, and a connecting plate 622 connected between the primary and secondary locking plates 621, 621′. The primary and secondary locking plates 621, 621′ may have the same or different structure. In this embodiment, the primary and secondary locking plates 621, 621′ have the same structure. Only the structure of the primary locking plate 621 will thus be described hereinafter.

The primary locking plate 621 includes a pivot-connecting portion 623 having a pivot hole for extension of one of the first pivot pins 61 therethrough, a first spring pulling portion 624 extending from the pivot-connecting portion 623 to connect with one end of the connecting plate 622, a second engaging portion 625 extending between and disposed below the pivot-connecting portion 623 and the first spring pulling portion 624, and a first retaining portion 626 protruding from the pivot-connecting portion 623 in a direction away from the second engaging portion 625. In this embodiment, the second engaging portion 625 includes an engaging groove 6251 releasably engageable with one of the first engaging portions 227. It should be noted that it is sufficient for the secondary locking plate 621′ to have the pivot-connecting portion 623 for extension of the other one of the first pivot pins 61 therethrough and the second engaging portion 625 with the engaging groove 6251 for releasable engagement with the other one of the first engaging portions 227, and may be dispensed with the first spring pulling portion 624 and the first retaining portion 626.

The second locking member 64 is pivotally mounted on the brewing-supporting frame 32 by a second pivot pin 63, and is disposed in proximity to and rearwardly of the primary locking plate 621. The second locking member 64 includes a pivot-connecting portion 641 for extension of the second pivot pin 63 therethrough, an unlocking portion 642 extending from the pivot-connecting portion 641 toward the unlocking piece 223, a second retaining portion 643 extending from the pivot-connecting portion 641 toward the first retaining portion 626 of the primary locking plate 621, and a second spring pulling portion 644 extending upward from the pivot-connecting portion 641. The second spring pulling portion 644 and the second retaining portion 643 are disposed on two opposite sides of the second pivot pin 63. The unlocking portion 642 has a second inclined face 645. The first inclined face 225 abuts against and pushes the second inclined face 645 to cause the second locking member 64 to pivot when the upper cover 3 is moved to a covering position.

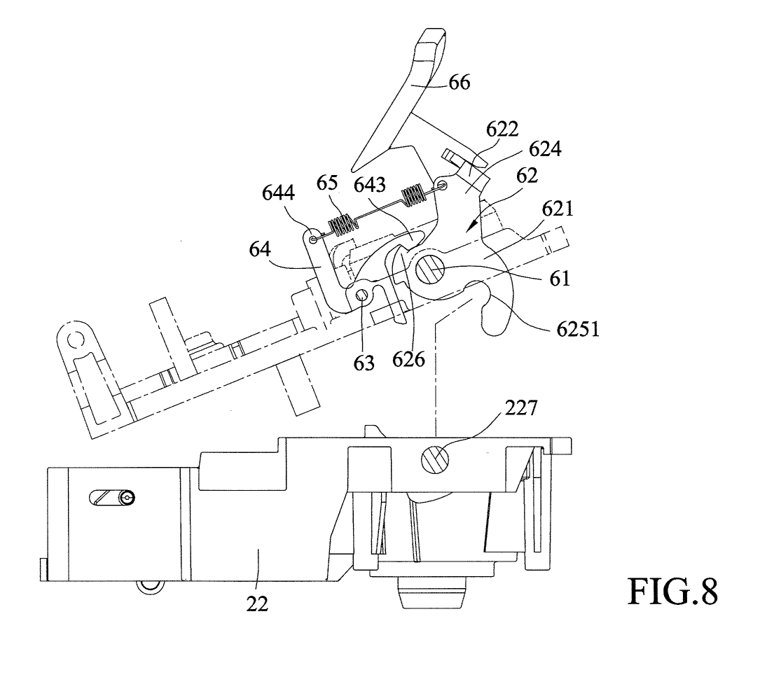

Two opposite ends of the locking spring 65 are hooked to the second spring pulling portion 644 of the second locking member 64 and the first spring pulling portion 624 of the primary locking plate 621 of the first locking member 62, respectively. Through the pulling force of the locking spring 65, the first and second locking members 62, 64 are urged to move toward a locking position in which the second retaining portion 643 is releasably engaged to the first retaining portion 626 of the primary locking plate 621, as shown in FIG. 8.

In this embodiment, the handle 66 is used to control pivoting of the first locking member 62, and includes an operating plate 661 protruding forwardly from the upper cover 3, and two spaced-apart clamping plates 662 projecting downward from the operating plate 661 into the insert slots 314 of the upper cover 3, respectively. Each clamping plate 662 has a clamping groove 663 clampingly receiving the connecting plate 622.

With reference to FIGS. 1, 2, and 4 to 6, when the upper cover 3 is in the covering position, the coffee capsule 10 is supported on the capsule-supporting frame 23, and the torsion spring 5 stores a force to bias the upper cover 3 to pivot to the open position along the opening direction 14. Further, the second engaging portions 625 of the primary and secondary locking plates 621, 621′ of the first locking member 62 are respectively engaged to the first engaging portions 227 of the lower main body 2. Thus, the upper cover 3 is firmly engaged to the lower main body 2 so as to ensure that the upper cover 3 will not be opened during a high temperature brewing of the coffee. On the other hand, because the unlocking portion 642 of the second locking member 64 abuts against the top face of the lateral frame 222 with the unlocking piece 223, the second locking member 64 can overcome a resilient force of the locking spring 65. Further, the second retaining portion 643 of the second locking member 64 and the first retaining portion 626 of the primary locking plate 621 are spaced apart from each other. That is, the first and second locking members 62, 64 are disposed in an unlocking position.

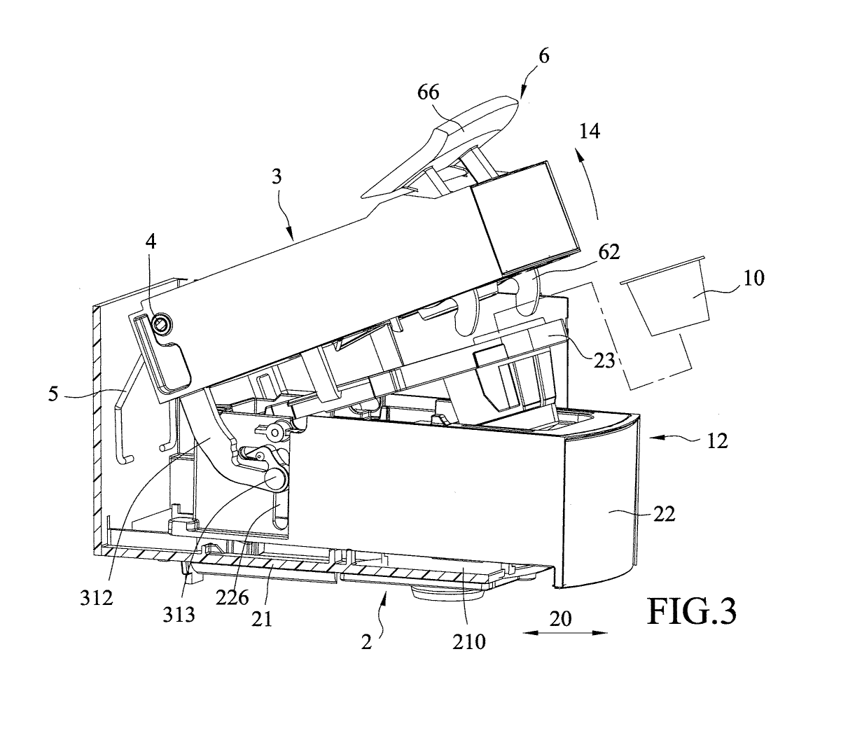

With reference to FIGS. 3 and 6 to 8, to remove the used coffee capsule 10 and place a new one in the capsule coffee machine 1, the handle 66 is first pulled along the opening direction 14 to drive the first locking member 62 to pivot about the first pivot pins 61. When the second engaging portions 625 of the first locking member 62 are respectively disengaged from the first engaging portions 227 of the lower main body 2, because the stored biasing force of the torsion spring 5 is released, the upper cover 3 is biased by the torsion spring 5 to pivot about the main shaft 4 toward the opening direction 14 to the open position. During pivoting of the upper cover 3 toward the opening direction 14, the following two actions are generated:

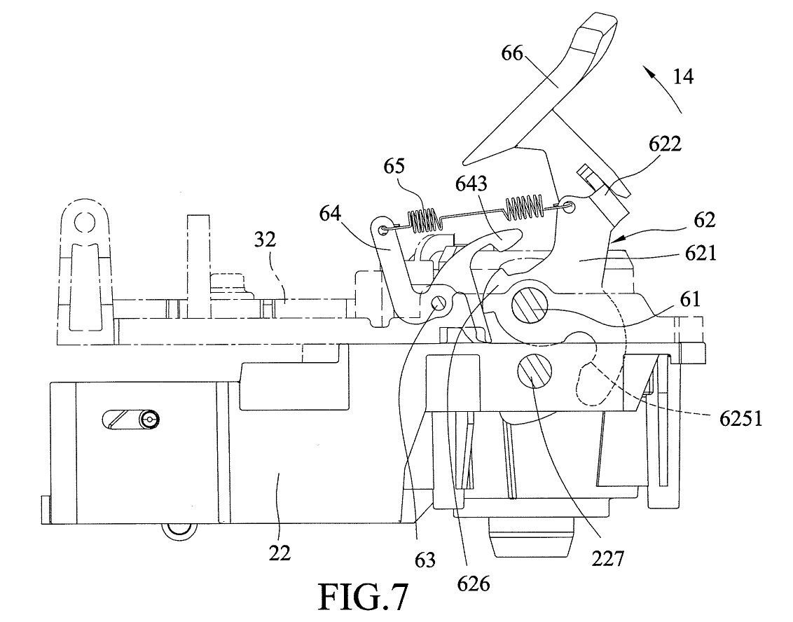

1) In following the upward movement of the upper cover 3, the unlocking portion 642 of the second locking member 64 will gradually move away from the lower main body 2. At this moment, the locking spring 65 will pull the second spring pulling portion 644 of the second locking member 64 and the first spring pulling portion 624 of the primary locking plate 621 toward each other until the second retaining portion 643 engages the first retaining portion 626 of the primary locking plate 621, thereby switching the first and second locking members 62, 64 from the unlocking position shown in FIG. 7 to the locking position shown in FIG. 8. At this time, the locking mechanism 6 has a fixed angular relationship, and pivots along with the upper cover 3 toward the opening direction 14.

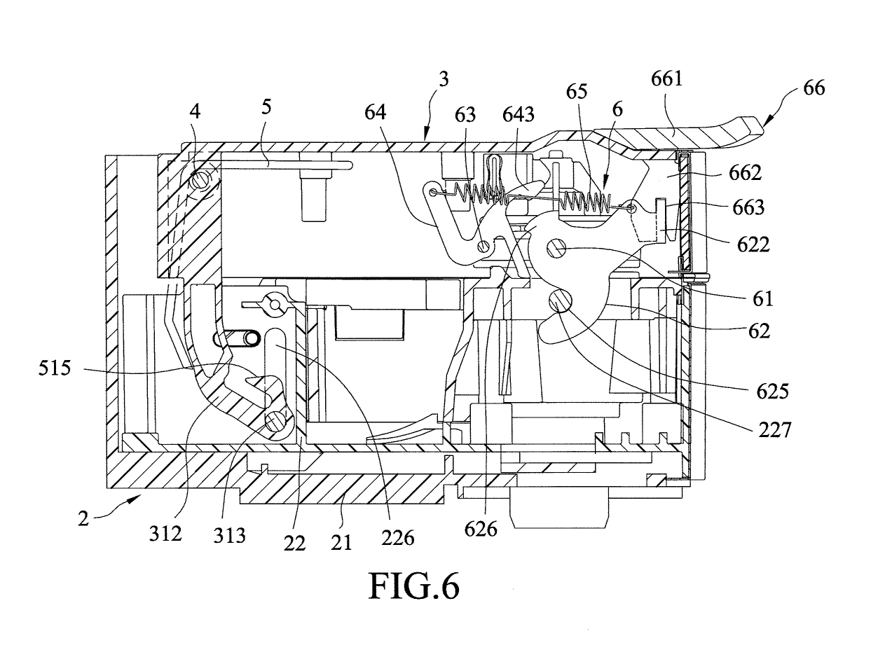

2) On the other hand, the slide pins 313 that are connected to the push-pull rods 312 of the upper cover 3 will move upward along the slide guide grooves 226 of the sliding body portion 22, and the sliding body portion together with the capsule-supporting frame 23 is pushed outwardly and forwardly by the push-pull rods 312. That is, when the upper cover 3 is switched from the covering position shown in FIG. 6 to the open position shown in FIG. 3, the sliding body portion 22 will move forwardly and outwardly along the sliding direction 20 relative to the fixed body portion 21. Because the sliding body portion 22 as well as the capsule-supporting frame 23 will protrude out of the accommodation space 210 when the upper cover 3 is in the open position, the coffee capsule 10 can be easily and safely removed from the capsule-supporting frame 23.

When the upper cover 3 is in the open position, the first and second locking members 62, 64 are in the locking position, as shown in FIG. 8. That is, the primary locking plate 621 of the first locking member 62 and the second locking member 64 are engaged to each other. When the upper cover 3 is pressed down along a direction opposite to the opening direction 14, a front end of the upper cover 3 will overcome the resilient force of the torsion spring 5 and moves downward. During the downward movement of the upper cover 3 toward the lower main body 2, in addition to using the push-pull rods 312 to pull the sliding body portion 22 to retract into the accommodation space 210 of the fixed body portion 21, the second engaging portions 625 of the first locking member 62 are also moved to lower fronts of the respective first engaging portions 227.

When the unlocking portion 642 of the second locking member 64 approaches the unlocking piece 223 of the sliding body portion 22, through pushing of the first inclined face 225 of the unlocking piece 223, the second locking member 64 can overcome the resilient force of the locking spring 65 so as to switch to the unlocking position, as shown in FIG. 7. At this moment, the handle 66 is pressed down to drive the first locking member 62 to pivot about the first pivot pins 61 and engage the second engaging portions 625 with the respective first engaging portions 227. Through the first inclined face 225 of the unlocking piece 223 and the second inclined face 645 of the unlocking portion 642 of the second locking member 64, the second locking member 64 can be guided to pivot smoothly. Since the first and second inclined faces 225, 645 are non-vertical, buffering and friction-reducing effects can be achieved.

The main, focus of this invention is to ensure engagement between the lower main body 2 and the upper cover 3, and facilitate closing of the upper cover 3.

With regard to how the coffee capsule 10 can be removed from capsule-supporting frame 23 after brewing is not a main aspect of this invention, so that a detailed description thereof is dispensed herewith.

From the foregoing, it will be seen that the capsule coffee machine 1 having the locking device 12 of this invention not only has an innovative structure, but also during brewing, through the configuration of the locking device 12 that engages the upper cover 3 with the lower main body 2, safety is ensured during the brewing process.

Further, during opening of the upper cover 3, by pulling the handle 66 along the opening direction 14, the upper cover 3 and the handle 66 can be simultaneously opened. During closing of the upper cover 3, since the handle 66 is engaged to the first locking member 62 and the first locking member 62 is engaged to the second locking member 64, when the upper cover 3 is moved down, the handle 66 and the first locking member 62 will not pivot due to misoperation. That is, it is assured that the second engaging portions 625 of the first locking member 62 will gradually move downward and then rearward from the top front of the first engaging portions 227 of the sliding body portion 22. When the unlocking portion 642 of the second locking member 64 touches the unlocking piece 223 of the sliding body portion 22, the second locking member 64 is disengaged from the first locking member 62, and the handle 66 can be pressed down to engage the second engaging portions 625 with the first engaging portions 227. Hence, this invention can prevent misoperation of the handle 66 to ensure smooth closing operation of the capsule coffee machine 1.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A locking device comprising:
a lower main body having an unlocking piece and at least one first engaging portion;
an upper cover connected pivotally to and openably covering said lower main body; and
a locking mechanism including a first locking member pivotally mounted on said upper cover, a second locking member pivotally mounted on said upper cover in proximity to said first locking member, a locking spring urging said first and second locking members to move toward a locking position, and a handle mounted on said upper cover to control pivoting of said first locking member, said first locking member including a primary locking plate having a first retaining portion, and a second engaging portion releasably engageable with said first engaging portion, said second locking member having a second retaining portion releasably engageable with said first retaining portion, and an unlocking portion corresponding to said unlocking piece;
wherein, when said upper cover is in a covering position, said second engaging portion engages said first engaging portion, and said first retaining portion disengages from said second retaining portion so that said first and second locking members are disposed in an unlocking position; and
wherein, when said handle drives said first locking member to pivot, said second engaging portion disengages from said first engaging portion, and said locking spring pulls said first and second locking members toward engagement with each other to switch said first and second members from the unlocking position to the locking position.

2. The locking device as claimed in claim 1, wherein said first locking member further includes a secondary locking plate parallel to and spaced apart from said primary locking plate, and a connecting plate connected between said primary and secondary locking plates, said handle having an operating plate protruding from said upper cover, and at least one clamping plate projecting from said operating plate into an interior of said upper cover, said clamping plate having a clamping groove clampingly receiving said connecting plate.

3. The locking device as claimed in claim 2, wherein said at least one first engaging portion includes two said first engaging portions spaced apart from each other in a left-right direction, each of said first engaging portions being in the form of an insert pin, said secondary locking plate also having a second engaging portion, said second engaging portions of said primary and secondary locking plates respectively engaging said first engaging portions when said upper cover is in the covering position.

4. The locking device as claimed in claim 1, wherein said unlocking piece has a first inclined face, said unlocking portion having a second inclined face, said first inclined face abutting against and pushing said second inclined face to cause said second locking member to pivot when said upper cover is moved to the covering position.

5. The locking device as claimed in claim 1, further comprising a main shaft for pivotally mounting said upper cover to said lower main body, said locking mechanism further including a first pivot pin for pivotally mounting said first locking member to said upper cover, and a second pivot pin for pivotally mounting said second locking member to said upper cover.

6. The locking device as claimed in claim 5, further comprising a torsion spring sleeved on said main shaft for biasing said upper cover to an open position.

7. The locking device as claimed in claim 6, wherein said first locking member further includes a secondary locking plate parallel to and spaced apart from said primary locking plate, and a connecting plate connected between said primary and secondary locking plates, said handle having an operating plate protruding from said upper cover, and at least one clamping plate projecting from said operating plate into an interior of said upper cover, said clamping plate having a clamping groove clampingly receiving said connecting plate.

8. The locking device as claimed in claim 7, wherein said at least one first engaging portion includes two said first engaging portions spaced apart from each other in a left-right direction, each of said first engaging portions being in the form of an insert pin, said secondary locking plate also having a second engaging portion, said second engaging portions of said primary and secondary locking plates respectively engaging said first engaging portions when said upper cover is in the covering position.

9. The locking device as claimed in claim 8, wherein said unlocking piece has a first inclined face, said unlocking portion having a second inclined face, said first inclined face abutting against and pushing said second inclined face to cause said second locking member to pivot when said upper cover is moved to the covering position.

10. A capsule coffee machine for brewing coffee from a coffee capsule, comprising:
a housing; and
a locking device mounted in said housing and including
a lower main body having an unlocking piece and at least one first engaging portion,
an upper cover connected pivotally to and openably covering said lower main body, and
a locking mechanism including a first locking member pivotally mounted on said upper cover, a second locking member pivotally mounted on said upper cover in proximity to said first locking member, a locking spring urging said first and second locking members to move toward a locking position, and a handle mounted on said upper cover to control pivoting of said first locking member, said first locking member including a primary locking plate having a first retaining portion, and a second engaging portion releasably engageable with said first engaging portion, said second locking member having a second retaining portion releasably engageable with said first retaining portion, and an unlocking portion corresponding to said unlocking piece,
wherein, when said upper cover is in a covering position, said second engaging portion engages said first engaging portion, and said first retaining portion disengages from said second retaining portion so that said first and second locking members are disposed in an unlocking position, and
wherein, when said handle drives said first locking member to pivot, said second engaging portion disengages from said first engaging portion, and said locking spring pulls said first and second locking members toward engagement with each other to switch said first and second members from the unlocking position to the locking position; and
a brewing unit disposed in said upper cover.

11. The capsule coffee machine as claimed in claim 10, wherein said locking device further includes a main shaft for pivotally mounting said upper cover on said lower main body, and a torsion spring sleeved on said main shaft for biasing said upper cover to pivot to an open position.

12. The capsule coffee machine as claimed in claim 10, wherein said first locking member further includes a secondary locking plate parallel to and spaced apart from said primary locking plate, and a connecting plate connected between said primary and secondary locking plates, said handle having an operating plate protruding from said upper cover, and at least one clamping plate projecting from said operating plate into an interior of said upper cover, said clamping plate having a clamping groove clampingly receiving said connecting plate.

13. The capsule coffee machine as claimed in claim 11, wherein said lower main body includes a fixed body portion, and a sliding body portion slidably mounted to said fixed body portion and provided with said unlocking piece, said fixed body portion having an accommodation space for accommodating said sliding body portion, said upper cover including an outer frame, and a brewing-supporting frame disposed in said outer frame for supporting said brewing unit, said outer frame including two push-pull rods spaced apart from each other in a left-right direction, said push-pull rods pushing said sliding body portion to move out of said accommodation space when said upper cover moves to the open position and pulling said sliding body portion to move into said accommodation space when said upper cover moves to the covering position.

14. The capsule coffee machine as claimed in claim 13, wherein said unlocking piece has a first inclined face, said unlocking portion having a second inclined face, said first inclined face abutting against and pushing said second inclined face to cause said second locking member to pivot when said upper cover is moved to the covering position.

15. The capsule coffee machine as claimed in claim 14, wherein said locking mechanism further includes a first pivot pin for pivotally mounting said first locking member to said upper cover, and a second pivot pin for pivotally mounting said second locking member to said upper cover.
